(19) United States
(12) Patent Application Publication
(10) Pub. No.: US 2014/0093326 A1
(43) Pub. Date: Apr. 3, 2014

(54) Floating Fastener and Packaging Structure Therefor

(71) Applicant: Ting-Jui WANG, New Taipei CIty (TW)

(72) Inventor: Ting-Jui WANG, New Taipei CIty (TW)

(21) Appl. No.: 13/829,769

(22) Filed: Mar. 14, 2013

(30) Foreign Application Priority Data
Sep. 28, 2012 (TW) 101135784

(51) Int. Cl. F16B 39/22; F16B 37/06

(52) U.S. Cl. CPC F16B 39/22; F16B 37/06
USPC 411/103

(57) ABSTRACT

A floating fastener for mounting to a first object and then fastening into a second object includes a fastening main body having, from top to bottom, sequentially connected handling portion, shank portion and fastening portion; a cap portion having a connecting section connected to the handling portion and a first stop section extended into the cap portion; and a sleeve movably located around the shank portion and having a second stop section movably interfering with the first stop section for the sleeve and the cap portion to movably connect together without separating from each other, a floating displacement limiting section located below the second stop section and horizontally abutted on the first stop section for preventing the sleeve from swaying, and a fixing section formed around a lower end of the sleeve. The floating fastener can possess a degree of floating displacement without having a swaying or inclined sleeve.

### CROSS-REFERENCE TO RELATED APPLICATION

This non-provisional application claims priority under 35 U.S.C. §119(a) on Patent Application No(s). 101135784 filed in Taiwan, R.O.C. on Sep. 28, 2012, the entire contents of which are hereby incorporated by reference.

### FIELD OF THE INVENTION

The present invention relates to a fastener and a packaging structure therefor, and more particularly to a floating fastener and a packaging structure therefor.

### BACKGROUND OF THE INVENTION

A conventional fastener, such as a telescopic screw, a floating screw or the like, usually includes a sleeve and a screw; and a floating space is left between the sleeve and the screw. When using the conventional fastener to lock two printed circuit boards (PCBs) together, first fix the sleeve to the first PCB and then extend the screw through the sleeve and the first PCB to lock to the second PCB. In case the first and the second PCB are not completely aligned with each other, an operator may utilize the floating space to bias the screw for the latter to lock to the second PCB.

Generally, the fastener is fixed to the first PCB by means of surface-mount technology. With the surface-mount technology, the fastener is picked up with a vacuum suction device and moved to a planned position on the first PCB before a welding process is conducted to fix the fastener to the first PCB. However, when using the vacuum suction device to suck the fastener, the sleeve tends to sway or incline due to the existence of the floating space and accordingly, could not be accurately placed on the planned position on the first PCB.

Further, for the vacuum suction device to fully pick up the fastener by a suction force, the fastener to be picked up must be positioned in an upright, stable and still state. A swaying fastener or an inclined fastener caused by some other factors could not be fully sucked by the vacuum suction device and accordingly could not be accurately moved to the planned position on the first PCB.

It is therefore tried by the inventor to develop a floating fastener that has a structure capable of preventing a sleeve thereof from swaying or inclining, and a packaging structure for immovably holding at least one floating fastener therein, so that the floating fastener does not sway or incline when being handled.

### SUMMARY OF THE INVENTION

A primary object of the present invention is to provide a floating fastener that possesses a degree of floating displacement and effectively prevents a sleeve thereof from swaying or inclining.

To achieve the above and other objects, the floating fastener according to the present invention is designed for fixedly mounting to a first object and fastening into a second object, and includes a fastening main body, a cap portion and a sleeve. The fastening main body has, from top to bottom, sequentially connected handling portion, shank portion and fastening portion, and the fastening portion being formed at the shank portion. The cap portion has a connecting section connected to the handling portion, and a first stop section being a first flange extended into an inner side of the cap portion. The sleeve is movably located around the shank portion and the fastening portion; and includes a second stop section, a floating displacement limiting section and a fixing section. The second stop section is a second flange extended from an outer surface of the sleeve to movably interfere with the first stop section for the sleeve and the cap portion to movably connect together without separating from each other. The floating displacement limiting section is located below the second stop section to horizontally abut on the first stop section for preventing the sleeve from swaying relative to the cap portion. The fixing section is formed at a lower end of the sleeve for fixing to the first object.

According to an embodiment of the present invention, the floating displacement limiting section and the second stop section together form a stepped structure with the second stop section radially protruding from a top of the floating displacement limiting section.

According to an embodiment of the present invention, the floating displacement limiting section forms a third flange diametrically smaller than the second flange.

According to an embodiment of the present invention, the floating displacement limiting section is in the form of a beveled structure, which is inclined from the second stop section toward the fixing section.

According to an embodiment of the present invention, the floating fastener further includes an elastic element movably fitted around the shank portion of the fastening main body with two opposite ends of the elastic element pressed against the handling portion and a shoulder section formed on an inner wall surface of the sleeve.

According to an embodiment of the present invention, the fastening portion can be a screwing structure or a hooking structure.

According to an embodiment of the present invention, the fastening main body and the cap portion are integrally formed with each other.

According to an embodiment of the present invention, the fixing section of the sleeve of the floating fastener is fixed onto the first object by means of soldering, welding, press-fit, flare fitting, bonding, magnetic attraction or snap fitting.

According to an embodiment of the present invention, the second flange forming the second stop section of the sleeve can be differently designed to have a beveled edge, a rectangular edge or a rounded edge.

Another object of the present invention is to provide a packaging structure for the floating fastener designed according to the present invention, so that the floating fasteners packaged in the packaging structure are effectively prevented from swaying or inclining.

To achieve the above and other objects, the packaging structure according to the present invention includes at least one fastener-confining holder internally defining a retaining space for immovably holding one floating fastener therein.

Therefore, the floating fastener designed according to the present invention can possess a degree of floating displacement while effectively prevents the sleeve thereof from swaying or inclining. Further, the packaging structure designed according to the present invention can also prevent the floating fasteners packaged therein from swaying or inclining.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view of a floating fastener according to a first embodiment of the present invention;

FIG. 2 shows the use of a vacuum suction device to pick up the floating fastener according to the first embodiment of the present invention and move the floating fastener to a specified place;

FIG. 3 shows the mounting of the floating fastener according to the first embodiment of the present invention on a first object;

FIG. 4 shows the first object having the floating fastener of the present invention mounted thereon is placed on a second object;

FIG. 5 shows the floating fastener of FIG. 4 is fastened to the second object;

FIG. 6 is a sectional view of a floating fastener according to a second embodiment of the present invention;

FIG. 7 shows the use of a punching device to punch the floating fastener according to the second embodiment of the present invention;

FIG. 8 shows the floating fastener according to the second embodiment of the present invention is driven through the first object by the punching device;

FIG. 9 is a sectional view of a floating fastener according to a third embodiment of the present invention;

FIG. 10 is a sectional view of a packaging structure for the floating fastener according to the present invention; and

FIGS. 11 to 14 show some different designs for a second stop section on a sleeve of the floating fastener according to the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

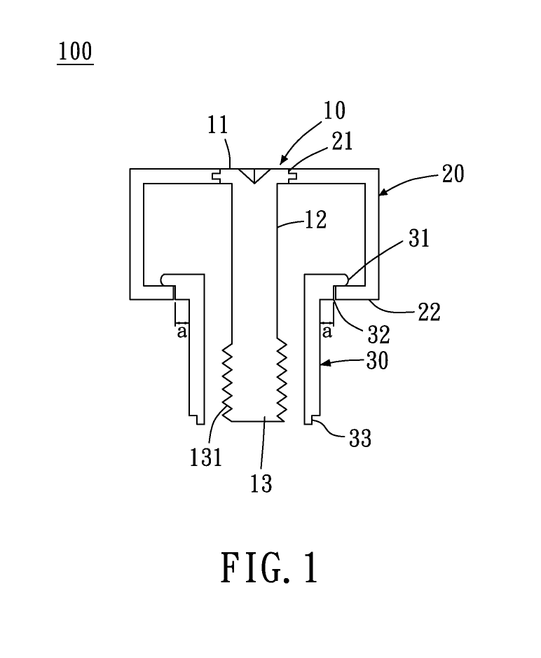

Please refer to FIGS. 1 to 5, in which a floating fastener 100 according to a first embodiment of the present invention is shown. The floating fastener 100 includes a fastening main body 10, a cap portion 20, and a sleeve 30.

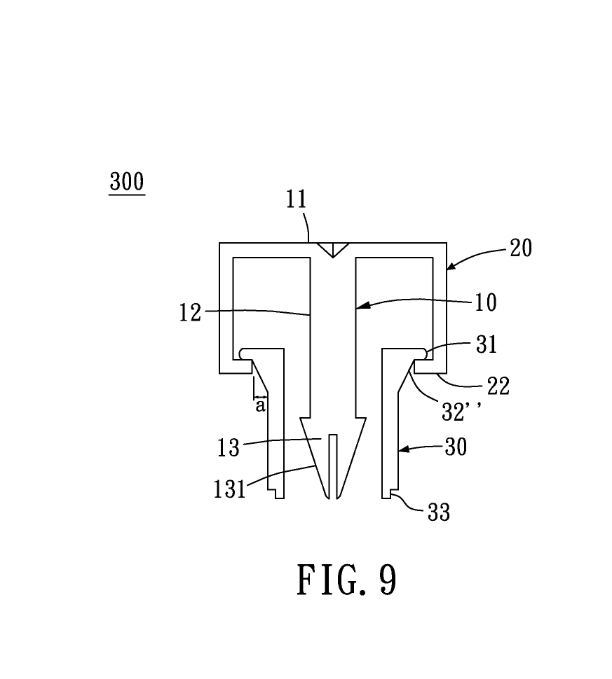

The fastening main body 10 includes, from top to bottom, sequentially connected handling portion 11, shank portion 12 and fastening portion 13. By working the handling portion 11, the floating fastener 100 can be fastened into a second object 4. The fastening portion 13 can be a screwing structure 131 or a hooking structure 132 as that shown in FIG. 9.

The cap portion 20 has a connecting section 21 and a first stop section 22. The connecting section 21 is connected to the handling portion 11 of the fastening main body 10, and the first stop section 22 is a first flange extended into an inner side of the cap portion 20. According to the present invention, the handling portion 11 of the fastening main body 10 can be connected to the connecting section 21 of the cap portion 20 by means of snap fitting, press-fit, flare fitting, screwing, bonding, magnetic attraction or welding. Alternatively, the fastening main body 10 and the cap portion 20 can be integrally formed with each other, as shown in FIG. 9.

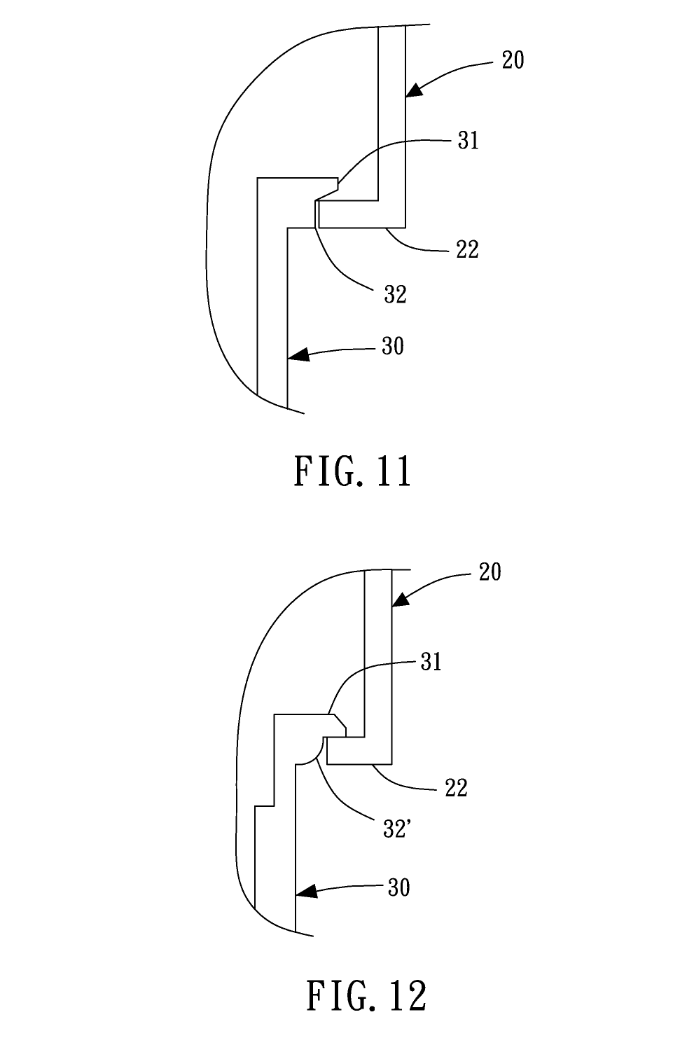

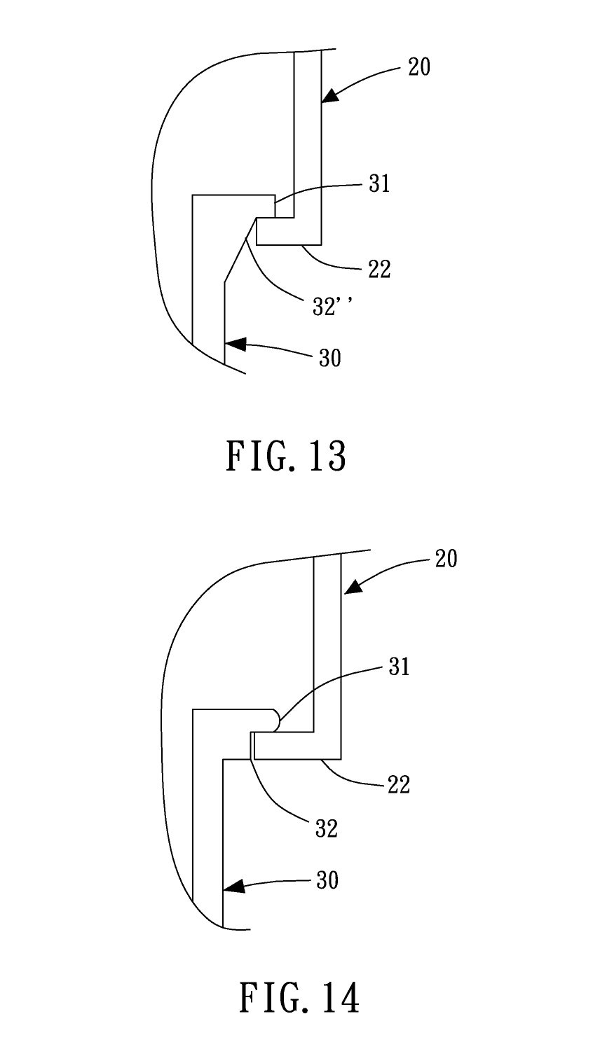

The sleeve 30 is movably located around the shank portion 12 and the fastening portion 13 of the fastening main body 10, and has a second stop section 31, a floating displacement limiting section 32 and a fixing section 33. The second stop section 31 is formed around an outer surface of the sleeve 30 and can be arranged around an upper end, a middle position, or any other suitable position of the sleeve 30. The second stop section 31 is a second flange outward extended from the sleeve 30 to movably interfere with the first stop section 22 of the cap portion 20, such that the sleeve 30 and the cap portion 20 are movably connected together without becoming separated from each other. According to the present invention, the second flange may be differently designed to have a beveled edge, such as those shown in FIGS. 11 and 12, a rectangular edge as that shown in FIG. 13, or a rounded edge as that shown in FIG. 14. The floating displacement limiting section 32 is located below the second stop section 31. When the floating fastener 100 is in a state as that shown in FIG. 1, the first stop section 22 horizontally abuts on the floating displacement limiting section 32 to prevent the sleeve 30 from swaying. Further, the floating displacement limiting section 32 and the second stop section 31 together form a stepped structure with the second stop section 31 radially protruding from a top of the floating displacement limiting section 32, The fixing section 33 is formed around a lower end of the sleeve 30 for fixing onto a first object 3, as shown in FIG. 3, by means of soldering, welding, press-fit, flare fitting, bonding, magnetic attraction or snap fitting. With the above arrangements, the sleeve 30 can have a floating displacement “a” relative to the cap portion 20. The floating displacement “a” is substantially equal to the size of the floating displacement limiting section 32. When the sleeve 30 is fixed onto the first object 3, the floating displacement “a” provides the fastening main body 10 of the floating fastener 100 with a lateral moving space, as shown in FIG. 5.

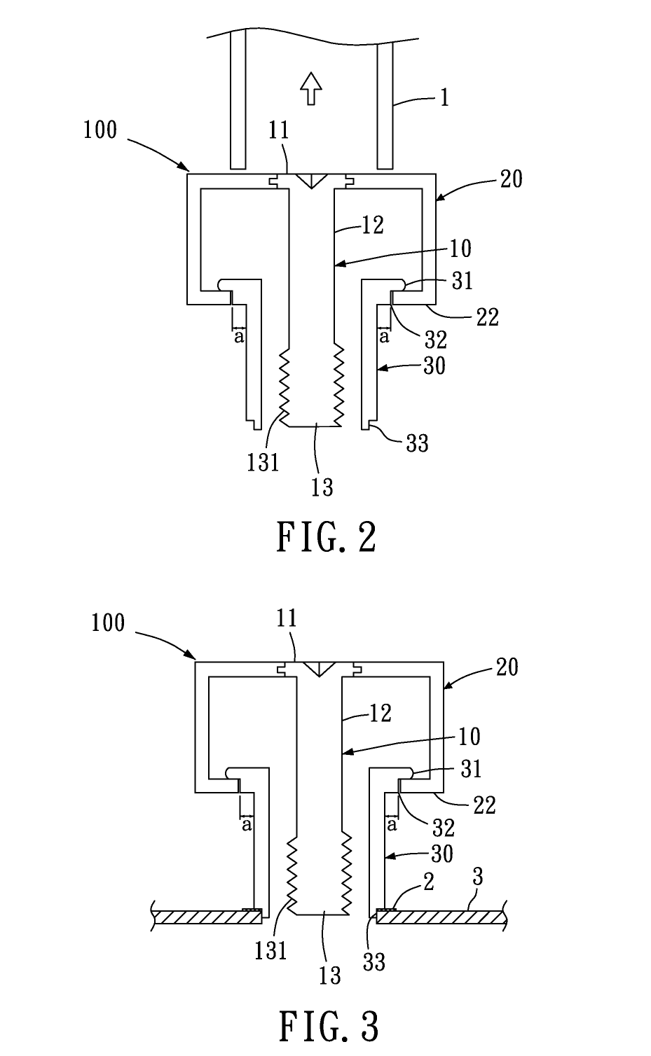

FIGS. 2 to 5 sequentially show the manner of using the floating fastener 100.

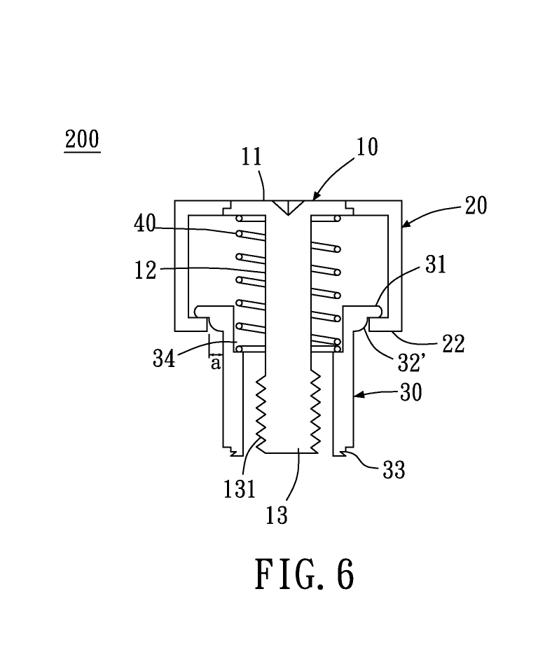

As shown in FIGS. 2 and 3, a user may use a vacuum suction device 1 or other suitable tools (not shown) to pick up the floating fastener 100 by a suction force or a clamping force and move the floating fastener 100 to a specified position on the first object 3. Alternatively, the user may manually pick up and move the floating fastener 100 to the specified position. The specified position is applied with solder paste 2 in advance, so that the floating fastener 100 can be welded to the first object 3 when the fixing section 33 of the sleeve 30 is moved to and aligned with the specified position. The first object 3 can be a printed circuit board (PCB) or a metal plate. In the illustrated first embodiment, the fixing section 33 is in the form of a stepped structure. In another embodiment of the present invention, the fixing section 33 can be formed into a serrate structure, as shown in FIG. 6.

According to the present invention, when the vacuum suction device 1 sucks and moves the floating fastener 100 to the specified position on the first object 3, the sleeve 30 of the floating fastener 100 would not sway because the first stop section 22 of the cap portion 20 is abutted on the floating displacement limiting section 32 of the sleeve 30. In this manner, not only the sleeve 30 is effectively prevented from separating from the cap portion 20 of the floating fastener 100, the sleeve 30 and the cap portion 20 are also effectively prevented from becoming inclined relative to each other. Further, since the sleeve 30 is prevented from inclining relative to the cap portion 20, the problem of not able to accurately mount the floating fastener 100 onto the first object 3 can also be avoided.

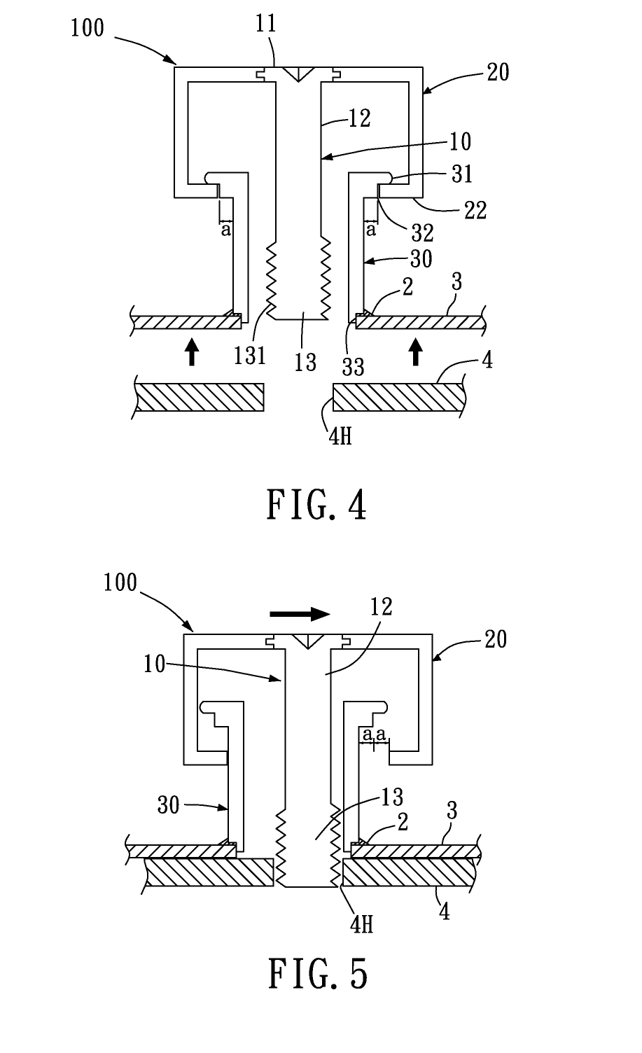

Please refer to FIG. 4. After the fixing section 33 of the sleeve 30 has been welded to the first object 3, the first object 3 with the floating fastener 100 welded thereto is superposed on the second object 4. Then, the fastening portion 13 of the fastening main body 10 is driven through the first object 3 into a fastening hole 4H on the second object 4, as shown in FIG. 5. However, in practical operation, it is possible the fastening hole 4H on the second object 4 is not concentrically aligned with the sleeve 30 of the floating fastener 100. Under this circumstance, the user may horizontally shift the fastening main body 10 relative to the sleeve 30 by a distance within the allowable floating displacement “a”. To do so, as shown in FIG. 5, first push the fastening main body 10 and accordingly the cap portion 20 downward for the floating displacement limiting section 32 of the sleeve 30 to separate from the first stop section 22 of the cap portion 20, and then horizontally shift the fastening main body 10 in a desired direction, which is the right side in FIG. 5, until the fastening portion 13 of the fastening main body 10 is aligned with the fastening hole 4H. In this case, a maximum distance by which the fastening main body 10 can be horizontally shifted is twice of the floating displacement “a”.

Therefore, with the above design, the floating fastener 100 of the present invention not only possesses a degree of floating displacement, but also effectively avoids the problem of swaying or inclined sleeve 30 and cap portion 20, so that the floating fastener 100 would not become separated from the second object 4 or unable to be fastened into the second object 4.

FIGS. 6 to 8 illustrate a floating fastener 200 according to a second embodiment of the present invention. As shown, the floating fastener 200 is generally structurally similar to the floating fastener 100, except for a floating displacement limiting section 32′ that forms a third flange diametrically smaller than the second flange, i.e. the second stop section 31; and an elastic element 40, such as a spring, being movably fitted around the shank portion 12 of the fastening main body 10 with two opposite ends of the elastic element 40 elastically pressing against the handling portion 11 and a shoulder section 34 formed on an inner wall surface of the sleeve 30 between the floating displacement limiting section 32′ and the fixing section 33. The floating fastener 200 with the above design can be effectively handled with an effortless manner.

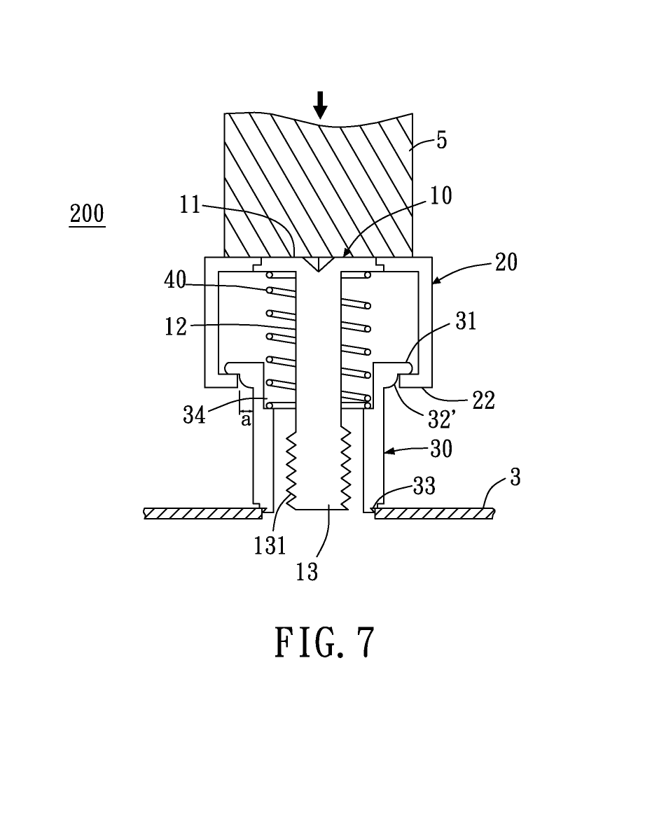

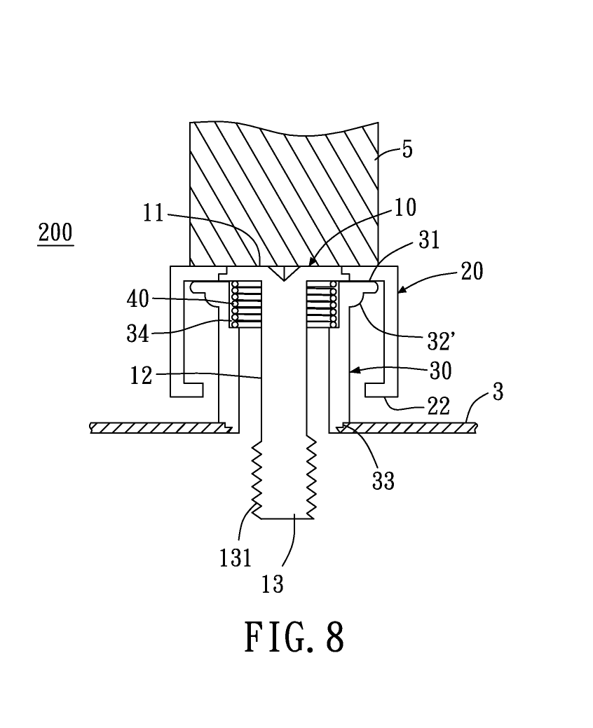

Please refer to FIGS. 7 and 8. A vacuum suction device or other suitable tools (not shown) can be used to pick up the floating fastener 200 by a suction force or a clamping force and move the floating fastener 200 to a specified position on the first object 3. Alternatively, the floating fastener 200 may be manually picked up and moved to the specified position. Then, a punching device 5 can be used to rivet a serrate fixing section 33 of the floating fastener 200 to the first object 3.

With the above design, it is able to effectively prevent the sleeve 30 of the floating fastener 200 from inclining relative to the cap portion 20 and accordingly ensure correct placement of the floating fastener 200 on the specified position on the first object 3. The above design also effectively prevents the cap portion 20 from inclining relative to the sleeve 30, enabling the punching device 5 to accurately punch the cap portion 20 without causing a damaged floating fastener 200.

FIG. 9 shows a floating fastener 300 according to a third embodiment of the present invention. As shown, the floating fastener 300 is generally structurally similar to the floating fastener 100 but includes a floating displacement limiting section 32″ in the form of a beveled structure, which is inclined from the second stop section 31 toward the fixing section 33 to facilitate movement of the sleeve 30 and the cap portion 20 relative to each other; a fastening portion 13 in the form of a hooking structure 132; and integrally formed fastening main body 10 and cap portion 20 to enable reduced manufacturing cost of the floating fastener 300.

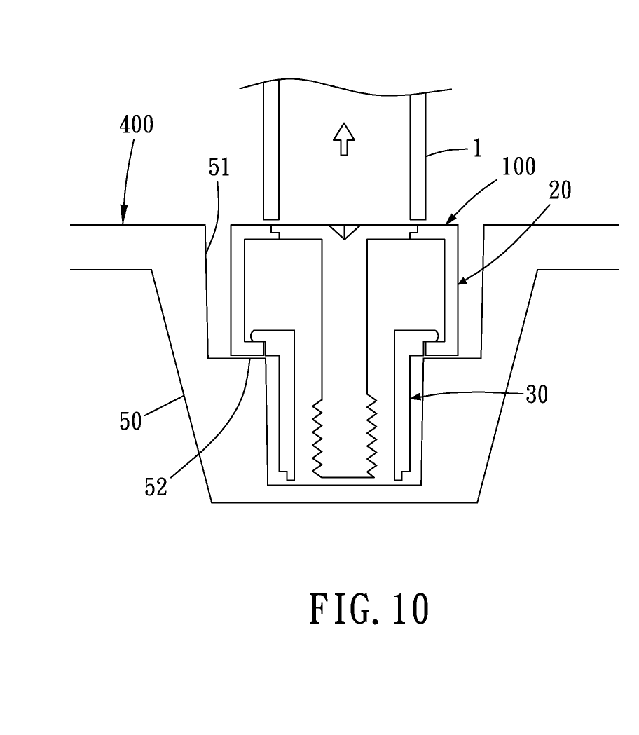

The present invention also provides a packaging structure 400 for the above-described floating fasteners 100, 200 and 300. FIG. 10 shows an embodiment of the packaging structure 400, which includes at least one fastener-confining holder 50 internally defining a retaining space 51 for immovably holding one floating fastener 100, 200, 300 therein. The fastener-confining holder 50 internally includes a stop shoulder portion 52, against which the cap portion 20 or the sleeve 30 is rest to thereby prevent the whole floating fastener 100, 200, 300 from swaying or inclining in the retaining space 51.

In summary, with the above design, the floating fastener according to the present invention not only possesses a degree of floating displacement, but also effectively avoids the problem of swaying or inclined sleeve and cap portion, so that the floating fastener would not become separated from the second object or unable to be fastened into the second object. Further, the packaging structure designed according to the present invention can also effectively prevent the floating fasteners retained therein against swaying or inclining. Therefore, when the floating fastener is picked up and moved to the specified position with the vacuum suction device or manually, the sleeve or the cap portion would not become inclined and the floating fastener is effectively protected against damage when being driven by the punching device.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A floating fastener for fixedly mounting to a first object and fastening into a second object, comprising:
a fastening main body including, from top to bottom, sequentially connected handling portion, shank portion and fastening portion, and the fastening portion being formed at the shank portion;
a cap portion having a connecting section and a first stop section; the connecting section being connected to the handling portion of the fastening main body, and the first stop section being a first flange extended into an inner side of the cap portion; and
a sleeve being movably located around the shank portion and the fastening portion of the fastening main body, and having:
a second stop section formed on an outer surface of the sleeve and being a second flange outward extended from the sleeve to movably interfere with the first stop section of the cap portion, such that the sleeve and the cap portion are movably connected without becoming separated from each other;
a floating displacement limiting section located below the second stop section and horizontally abutted on the first stop section, so that the sleeve is prevented from swaying; and
a fixing section formed at a lower end of the sleeve for fixing onto the first object.

2. The floating fastener as claimed in claim 1, wherein the floating displacement limiting section and the second stop section together form a stepped structure with the second stop section radially protruding from a top of the floating displacement limiting section.

3. The floating fastener as claimed in claim 1, wherein the floating displacement limiting section forms a third flange diametrically smaller than the second flange.

4. The floating fastener as claimed in claim 1, wherein the floating displacement limiting section is in the form of a beveled structure, which is inclined from the second stop section toward the fixing section.

5. The floating fastener as claimed in claim 1, further comprising an elastic element movably fitted around the shank portion of the fastening main body with two opposite ends of the elastic element pressed against the handling portion and a shoulder section formed on an inner wall surface of the sleeve.

6. The floating fastener as claimed in claim 1, wherein the fastening portion is a screwing structure.

7. The floating fastener as claimed in claim 1, wherein the fastening portion is a hooking structure.

8. The floating fastener as claimed in claim 1, wherein the fastening main body and the cap portion are integrally formed with each other.

9. The floating fastener as claimed in claim 1, wherein the fixing section of the sleeve is fixed onto the first object in a manner selected from the group consisting of soldering, welding, press-fit, flare fitting, bonding, magnetic attraction, and snap fitting.

10. The floating fastener as claimed in claim 1, wherein the second flange forming the second stop section of the sleeve has an edge selected from the group consisting of a beveled edge, a rectangular edge, and a rounded edge.

11. A packaging structure for packaging the floating fastener claimed in claim 1, comprising at least one fastener-confining holder internally defining a retaining space for immovably holding the floating fastener therein.
